(19) United States
(12) Patent Application Publication
(10) Pub. No.: US 2019/0151827 A1
(43) Pub. Date: May 23, 2019

(54) GAS TURBINE ENGINE WITH FUEL-CRACKING CATALYST

(71) Applicant: Hamilton Sundstrand Corporation, Charlotte, NC (US)

(72) Inventors: Tianli Zhu, Glastonbury, CT (US); Lance L. Smith, West Hartford, CT (US); Susanne M. Opalka, Old Chatham, NY (US)

(21) Appl. No.: 15/817,616

(22) Filed: Nov. 20, 2017

(51) Int. Cl. B01J 23/42; F02C 3/04; F02C 7/141; F02C 7/224; B01J 23/72; B01J 23/755; B01J 35/00; B01J 35/10; C10G 11/02

(52) U.S. Cl. CPC B01J 23/42; F02C 3/04; F02C 7/141; F02C 7/224; B01J 23/72; B01J 23/755; C10G 2300/708; B01J 35/1019; B01J 35/1023; C10G 11/02; F05D 2220/32; F05D 2260/20; F05D 2260/95; B01J 35/0013

(57) ABSTRACT

A gas turbine engine includes a combustor, a turbine section downstream of the combustor, a nozzle section downstream of the turbine section, a heat exchanger in the turbine section, in the nozzle section, or downstream of the nozzle section, and a fuel supply line for conveying fuel through the heat exchanger and to the combustor. The heat exchanger includes a fuel-cracking catalyst that has a protonated solid acid support and one or more transition metals that includes at least platinum.

### BACKGROUND

Fuel is widely known and used in the aircraft industry as a heat sink before combustion for cooling heat-producing aircraft components. For example, in aircraft having gas turbine engines, the fuel can be used to cool engine lubricating oil, bleed air from an engine compressor in a cabin air cycle control system, heat-producing aircraft components in a thermal management system, or engine turbine cooling air in a turbine film cooling system. In addition to the fuel's sensible heat capacity, the fuel heat sink is augmented by the onset of endothermic fuel cracking reactions, which both absorb heat with increasing temperature, especially above 300° F. The fuel endothermicity is determined by the types and distribution of cracked products formed, where unsaturated (dehydrogenated) products provide the greatest endothermicity.

However, the cooling capacity of fuel is limited above 350° F., by the tendency of fuel to undergo side-reactions that lead to the formation of coke deposits, which are highly reacted solid residues having C:H ratios greater than 1, that can interfere with fuel flow, heat transfer, and engine performance. The presence of dissolved oxygen initiates the formation of deposits commonly referred to as autoxidative “coke” or “coking” at temperatures between 350° F. and 850° F. Lowering the oxygen concentration over this temperature range can mitigate the coking problem. However, with increasing temperature there is also an exponentially increasing tendency towards coke formation from fuel cracking and pyrolysis side-reactions. Pyrolytic coke formation becomes significant above 850° F., even in the absence of oxygen. In addition, for some aircraft, an even greater cooling capacity is desired. For example, hypersonic aircraft or other types of propulsion devices or engines may operate under supercritical fuel conditions at temperatures near or above 850° F. and up to about 1700° F. At such temperatures and fuel densities, traditional fuel treatments may not provide enough fuel cooling capacity without the occurrence of coking.

### SUMMARY

A gas turbine engine according to an example of the present disclosure includes a combustor, a turbine section downstream of the combustor, a nozzle section downstream of the turbine section, a heat exchanger in the turbine section, in the nozzle section, or downstream of the nozzle section, and a fuel supply line for conveying fuel through the heat exchanger and to the combustor. The heat exchanger includes a fuel-cracking catalyst that has a protonated solid acid support and one or more transition metals that includes at least platinum, nickel, or copper.

A heat exchanger according to an example of the present disclosure includes a wall that has an exterior surface for conducting gas turbine engine combustion product gas. The wall defines an interior flow passage for conducting fuel. There is a fuel-cracking catalyst disposed in the interior flow passage. The fuel-cracking catalyst includes a protonated solid acid support and one or more transition metals that includes at least platinum, nickel, or copper.

A bi-functional fuel-cracking catalyst according to an example of the present disclosure includes a protonated solid acid support and 0.25-5% by weight of monodisperse metal catalyst clusters in the protonated solid acid support. The monodisperse metal catalyst clusters have a cluster size of no greater than 6 angstroms and comprise one or more transition metals including at least platinum, nickel, or copper.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates a gas turbine engine with a heat exchanger that has a fuel-cracking catalyst. The heat exchanger is downstream of the turbine section of the engine but upstream of the nozzle section of the engine.

FIG. 2 illustrates another example gas turbine engine with a heat exchanger that has a fuel-cracking catalyst. The heat exchanger in this example is in the turbine section of the engine.

FIG. 3 illustrates another example gas turbine engine with a heat exchanger that has a fuel-cracking catalyst. The heat exchanger in this example is downstream of the nozzle of the engine.

FIG. 4 illustrates a representative portion of an example heat exchanger.

FIG. 5 illustrates a representative portion of a fuel-cracking catalyst.

### DETAILED DESCRIPTION

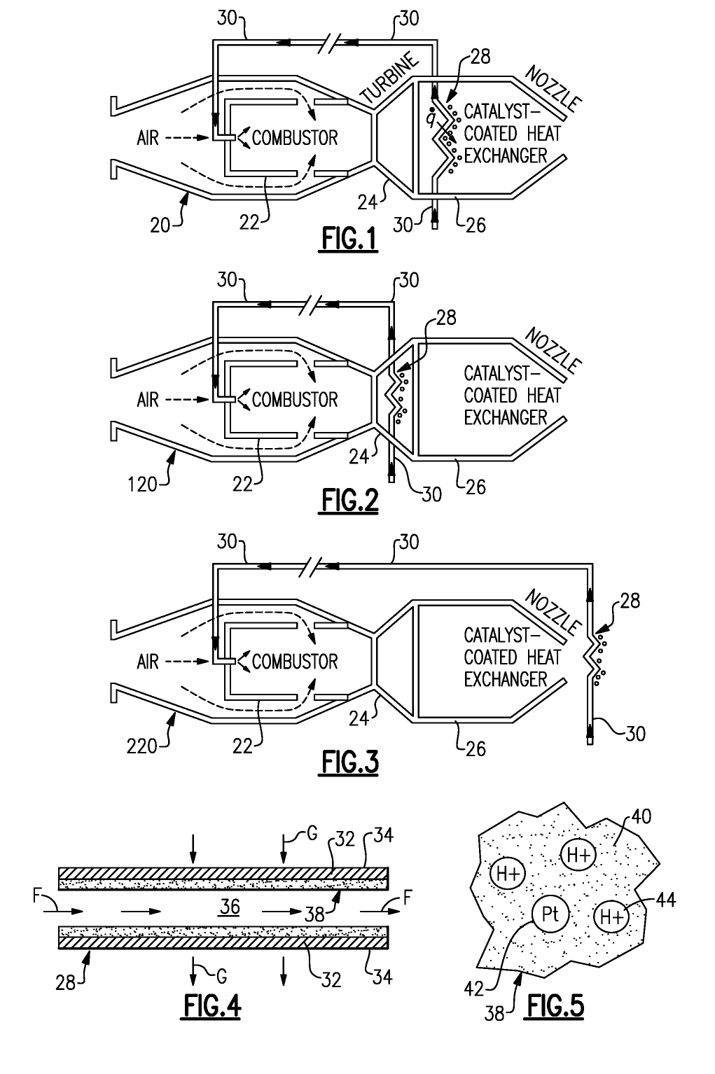

FIG. 1 schematically illustrates a gas turbine engine 20. In this example, the engine 20 at least includes a combustor 22, a turbine section 24 downstream of the combustor 22, a nozzle section 26 downstream of the turbine section 24, and a heat exchanger 28. In this example, the heat exchanger 28 is located downstream of the turbine section but upstream of the nozzle section 26. A fuel supply line 30 is connected to the heat exchanger 28 to convey fuel through the heat exchanger 28 and to the combustor 22. In one modified example of an engine 120 shown in FIG. 2, the heat exchanger 28 is instead located in the turbine section 24, such as between turbine stages. In another example of an engine 220 shown in FIG. 3, the heat exchanger 28 is instead located downstream of a nozzle. As will be appreciated, the examples herein may be applied to other types of engine architectures.

FIG. 4 illustrates a representative portion of the heat exchanger 28. The type of heat exchanger 28 is not particularly limited and may be, for example only, a tube and fin heat exchanger or a shell and tube heat exchanger. The heat exchanger 28 includes a wall 32 that has an exterior surface 34 for conducting combustion product gas, represented at G, from the combustor 22. The wall 32 defines an interior flow passage 36 for conducting fuel, represented at F. Thermal energy is transferred across the wall 32 between the gas G and the fuel F. Namely, the gas G heats the fuel F.

To enhance cooling capacity of the fuel F, the heat exchanger 28 includes a fuel cracking catalyst 38 disposed in the interior flow passage 36. For instance, as shown, the catalyst 38 is disposed as a fixed layer on the interior of the wall 32. Alternatively, the catalyst 38 could be provided as media or particles in a packed bed in the passage 36, or even as additive particles in the fuel to be circulated through the heat exchanger 28 with the fuel. The catalyst 38 chemically cracks and dehydrogenates the fuel F to increase the fuel endotherm and also recover waste heat from the engine 20, enabling the engine to operate at the same temperatures with less fuel, thereby enhancing engine efficiency. The increased endotherm provides the fuel F with a greater capacity to receive and remove heat. For example, prior to injection into the combustor 22, the fuel can be circulated through a heat source, such as a bearing, electronics, airframe, or an oil-fuel heat exchanger to cool the heat source.

The catalyst 38 is adapted for cracking and dehydrogenation of the fuel at high temperatures and pressures, such as temperatures in excess of 850° F. and as high as 1700° F. or at or near supercritical fuel conditions. At such temperatures or conditions, a typical cracking catalyst has low yield of endothermic products, such as olefins, which in turn provides low endothermic effect (i.e., low cooling effect). Coke formation is also a concern at these temperatures and conditions. In this regard, the catalyst 38 is designed to be bi-functional to provide good cracking and dehydrogenation at such temperatures and conditions, while reducing coke formation.

FIG. 5 shows a representative portion of the catalyst 38. The catalyst 38 includes a protonated solid acid support 40 and one or more transition metals at metal sites 42, including at least platinum, nickel, or copper. The support 40 includes acid sites 44, which are locations where donor protons are available (Brønsted acid sites). As an example, the support 40 is a molecular sieve, such as a zeolite or doped zeolite, or ceria-zirconia mixed oxide.

The metal, metal loading, and support are selected such that the adsorption or bonding interaction between hydrocarbon and metal sites 42 is stronger than the interaction between hydrocarbon and acid sites 44. In this regard, the acid sites 44 and the metal sites or clusters 42 are spaced more than 7 angstroms apart so that the cracked products of fuel hydrocarbon molecules cannot simultaneously bond with both sites. Kerosene-type jet fuels predominantly contain hydrocarbons with 8-16 carbon atoms, and typically form cracked hydrocarbon products with 3-8 carbon atoms. The hydrocarbons primarily bind to the metal and acid sites through their intermediate secondary and tertiary carbon backbone atoms. The feed hydrocarbons and intermediates can thus be dehydrogenated at the metal sites without simultaneously going through further isomerization or oligomerization on acid sites 44 to form heavy hydrocarbons or coke.

In one example, the catalyst 38 has a relatively low amount of platinum. For instance, the catalyst 38 has 0.25-5% by weight of platinum or, in a further example, 1-4% by weight platinum. In additional examples, the sites or clusters 42 of platinum are monodisperse and have a cluster size of no greater than 6 angstroms or no greater than 4 angstroms. Monodisperse Pt distribution provides the highest Pt utilization, where every Pt atom is accessible to participate in hydrocarbon conversion reactions. Such a cluster size reduces the chance of blocking pore channels in the support 40, which may have diameters less than 5 or 7 angstroms.

In further examples, the support 40 is a zeolite that has a surface area of 100-1000 meters squared per gram and a selected ratio of silica to alumina (“SAR”). The acid sites 44 are formed by the substitution of Al for Si in the silica framework of the zeolite. The Al has a +3 charge and is tetrahedrally coordinated to oxygen in the same arrangement as the +4 charged Si. The substitution locations are thus negatively charged because the charge imbalance introduced by the lower Al charge, and are typically neutralized by protonation. Lower SARs thus represent higher concentration of Al and higher acidity, while higher SARs represent lower concentration of Al and lower acidity. To keep a good spacing between the metal sites 42 and the acid cites 44 for the example amount of platinum, the SAR of the support 40 is at least 11 and no greater than 25. For instance, a SAR of 11 and platinum loading of about 3.3 weight % is expected to yield one platinum atom for one out of eight acid sites 44. A good spacing can thus be maintained between the platinum and the acid site 44, assuming platinum monodispersion.

The table below lists further example of the catalyst 38.

| Weight % Pt | SAR (zeolite) |
|---|---|
| 0.5-4 | 11-15 |
| 0.3-2.5 | 15-20 |
| 0.25-2 | 20-25 |

In additional examples, the one or more metals at the metal sites 42 further include an alloy metal selected from rhenium, tin, palladium, or combinations thereof. The alloy metal may serve to modify the activity of the platinum, nickel, or copper, and may be provided up to about a 1:1 weight ratio with platinum, nickel, or copper. In the examples herein, the alloy metal may replace a percentage of the platinum, nickel, or copper, or be in addition to the percentage of platinum, nickel, or copper. In one further example, the one or more metals is at least a ternary alloy with platinum and two or more alloy metals.

The catalyst 38 may be fabricated using known processing techniques. Highly dispersed transition metals, platinum for example, loaded internally within aluminosilicate zeolite pores form stable bonds in the proximity of the acid sites 44. The transition metals can be loaded by impregnation of a transition metal salt precursor, such as the platinum precursor tetraamine platinum nitrate, followed by heat treatment, and optionally reduction.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A gas turbine engine comprising:
a combustor;
a turbine section downstream of the combustor;
a nozzle section downstream of the turbine section;
a heat exchanger in the turbine section, in the nozzle section, or downstream of the nozzle section;
a fuel supply line for conveying fuel through the heat exchanger and to the combustor,
wherein the heat exchanger includes a fuel-cracking catalyst comprising,
a protonated solid acid support, and
one or more transition metals including at least platinum, nickel, or copper.

2. The gas turbine engine as recited in claim 1, wherein the heat exchanger is downstream of the turbine section but upstream of the nozzle section.

3. The gas turbine engine as recited in claim 1, wherein the heat exchanger is downstream of the nozzle section.

4. The gas turbine engine as recited in claim 1, wherein the fuel-cracking catalyst has 0.25-5% by weight of platinum, nickel, or copper.

5. The gas turbine engine as recited in claim 1, wherein the fuel-cracking catalyst has 1-4% by weight of platinum, nickel, or copper.

6. The gas turbine engine as recited in claim 1, wherein the platinum, nickel, or copper, is in monodisperse metal catalyst clusters that have a cluster size of no greater than 6 angstroms.

7. The gas turbine engine as recited in claim 1, wherein the protonated solid acid support is a zeolite that has a ratio of silica to alumina that is at least 11 and no greater than 25.

8. The gas turbine engine as recited in claim 7, wherein the fuel-cracking catalyst has 0.25-5% by weight of platinum, nickel, or copper.

9. The gas turbine engine as recited in claim 8, wherein the platinum, nickel, or copper is in monodisperse metal catalyst clusters that have a cluster size of no greater than 6 angstroms.

10. The gas turbine engine as recited in claim 8, wherein the fuel-cracking catalyst has 1-4% by weight of platinum and the zeolite has a surface area of 100-1000 meters squared per gram.

11. The gas turbine engine as recited in claim 10, wherein the one or more transition metals, in addition to platinum, nickel, or copper, is selected from the group consisting of rhenium, tin, palladium, and combinations thereof.

12. The gas turbine engine as recited in claim 1, wherein the protonated solid acid includes acid sites and the one or more transition metals are at metal cites, and the acid sites and the metal sites are sufficiently spaced apart to prevent cracked products of fuel hydrocarbon molecules from simultaneously bonding with both the acid sites and the meal cites.

13. A heat exchanger comprising:
a wall including an exterior surface for conducting gas turbine engine combustion product gas, the wall defining an interior flow passage for conducting fuel; and
a fuel-cracking catalyst disposed in the interior flow passage, the fuel-cracking catalyst including a protonated solid acid support and one or more transition metals including at least platinum, nickel, or copper.

14. The heat exchanger as recited in claim 13, wherein the fuel-cracking catalyst has 0.25-5% by weight of platinum, nickel, or copper, and the platinum, nickel, or copper is in monodisperse metal catalyst clusters that have a cluster size of no greater than 6 angstroms.

15. The heat exchanger as recited in claim 14, wherein the protonated solid acid support is a zeolite that has a ratio of silica to alumina that is at least 11 and no greater than 25.

16. The heat exchanger as recited in claim 15, wherein the fuel-cracking catalyst has 1-4% by weight of platinum, nickel, or copper.

17. The heat exchanger as recited in claim 16, wherein the zeolite has a surface area of 100-1000 meters squared per gram.

18. A fuel-cracking catalyst comprising:
a protonated solid acid support; and
0.25-5% by weight of monodisperse metal catalyst clusters in the protonated solid acid support, the monodisperse metal catalyst cluster having a cluster size of no greater than 6 angstroms and comprising one or more transition metals including at least platinum, nickel, or copper.

19. The fuel-cracking catalyst as recited in claim 18, wherein the protonated solid acid support is a zeolite that has a ratio of silica to alumina that is at least 11 and no greater than 25.

20. The fuel-cracking catalyst as recited in claim 19, wherein the fuel-cracking catalyst has 1-4% by weight of platinum, nickel, or copper, and the zeolite has a surface area of 100-1000 meters squared per gram.
